(19) United States
(12) Patent Application Publication
(10) Pub. No.: US 2013/0323399 A1
(43) Pub. Date: Dec. 5, 2013

(54) Processed Garlic Formulation

(71) Applicant: Andrew Brian Davis, (US)

(72) Inventor: Andrew Brian Davis, (US)

(21) Appl. No.: 13/489,188

(22) Filed: Jun. 5, 2012

(51) Int. Cl. A23L 1/221

(52) U.S. Cl. 426/638

(57) ABSTRACT

A prepared garlic composition having at least two pre-acidified chopped garlic components each a having different sized chopped garlic particulate.

### BACKGROUND

This disclosure relates generally to food products, and more particularly, to preparations of processed garlic blends used as food products and to methods for processing and preparing such garlic blends.

Garlic is a low-acid vegetable, with the pH of a clove of garlic typically ranging from 5.3 to 6.3. Like all low-acid vegetables, garlic can support the growth and subsequent toxin production of the bacterium clostridium botulinum under the right conditions. Therefore, it is important to reduce the pH of packaged garlic to provide a successful commercial shelf-stable product, and thus, packaged garlic usually contains citric acid or phosphoric acid in order to increase the acidity. Some in the garlic processing industry refer to this as the “acidified campaign” in which the product is pasteurized by heat treatment to provide pH stability and improved shelf life.

Nevertheless, commercial garlic preparations (e.g., chopped, crushed, minced) tend to have a strong bite with a pungent flavor that is a characteristic of garlic, but is considered too strong by many consumers. Therefore, it would be desirable to have shelf stable garlic preparations which provide a softer flavor, or a different flavor or texture, than conventional garlic preparations.

### DETAILED DESCRIPTION

This disclosure describes preparations of processed garlic and methods for the production of processed garlic preparations.

Since pH control is critical for any packaged garlic preparation, the base for all compositions described herein includes at least half by proportion of pre-acidified chopped garlic components, such as chopped garlic in oil and chopped garlic in water. Pre-acidified ingredients are shelf stable and have a low pH, and can be used in combination with other higher acid ingredients (such as roasted chopped garlic, brined chopped peppers, etc.) to reduce and stabilize the pH of the other ingredients in a predictable and consistent manner. In addition, olive oil is added as approximately one tenth of the final blend, which also helps to reduce the pH of the final composition.

Preferably, extra-virgin olive oil with a buttery finish is used in the product blend to provide not only a component of pH control, but also to help improve flavor and compensate for the harsh “bite” traditionally associated with prepared garlic products.

The garlic “emulsion” that is produced as described herein looks like no other garlic product, in particular, through the use of different size particulates of garlic and other ingredients in various cuts and forms. In addition, a variety of flavors and textures can be provided in product preparations by combining the base emulsion with other carefully selected premium quality ingredients, such as Sicilian grown lemons, Vermont Butter, Grade A extra light amber clover honey, full seed mustards, and a wide variety of peppers and other vegetables.

The specific ingredients will be described first followed by examples of product compositions along with processing steps for making the compositions.

### Ingredient: Chopped Garlic in Oil

The ingredient “chopped garlic in oil” is roughly ⅛ inch pieces of chopped garlic that provide robust garlic pungency to the flavor profile of the blends described herein. This ingredient is generally available from commercial garlic processors, such as Christopher Ranch, Gilroy, Calif.; The Garlic Company, Bakersfield, Calif.; and Pacific Choice Brands, Inc., Fresno, Calif., and may be obtained in 5 gallon pails or larger drums. This garlic ingredient is “pre-acidified” through processing and thus has a stable pH for long term storage. To achieve this stability, the garlic is thermally processed as described below shortly after harvest (typically September through November in California) in order to stop further green vegetative growth and to reduce the high pH conditions which can lead to bacterial growth. For example, a typical processing method for “chopped garlic in oil” includes:

1. The harvested garlic bulbs are cracked, then the cloves are peeled, washed and sorted for defects.

2. The sorted cloves are then chopped into roughly ⅛ inch pieces.

3. The pieces are blended in a mixing kettle with a high-quality cooking oil and citric acid. In one embodiment, the blend by proportion is approximately: chopped garlic—83%; canola oil—13%; and citric acid—3%. Note that additional oil is already present in this base ingredient; although it may be desirable to use olive oil in this process to further improve the flavor profile.

4. The blended ingredients are then heated in the kettle to a minimum temperature of 180° F. for 9 minutes.

5. The heated blended product is then filled into 5 gallon pails (or larger drums) at a temperature adequate to pasteurize the product, for example, ranging from 160° F. to 190° F.

6. The pails (or drums) are inverted for a minimum of 20 minutes.

The chopped garlic in oil prepared as described above is now shelf-stable for three to seven years with a pH of 4.0 or less, and is ready to use as an ingredient, or may be stored for later processing.

### Ingredient: Chopped Garlic in Water

The ingredient “chopped garlic in water” is 3/16 inch to ⅜ inch finished size pieces of chopped garlic and provides a mellower flavor since some of the pungency of the garlic is diluted through dehydration and rehydration. This ingredient is also generally available from commercial garlic processors and may be obtained in 5 gallon pails or larger drums or totes. This garlic ingredient is also “pre-acidified” in order to have a stable pH for long term storage. To do so, the garlic is processed as described below shortly after harvest. For example, a typical processing method for “chopped garlic in water” includes:

1. The harvested garlic bulbs are cracked, then the cloves are peeled, washed and sorted for defects.

2. The sorted garlic is sliced and then dehydrated.

3. The dehydrated garlic is milled to specified particle size, for example 3/16 inch to ⅜ inch . This is larger than traditional minced garlic in water, which comes in very small 1/16 to ⅛ inch particulates.

4. The milled garlic is screened for precise uniform sizing of particulates as specified, then rehydrated by being mixed with hot water in a 4:1 ratio and then acidified with citric acid. The nature of dehydration and rehydration dilutes the natural pungency of garlic although this product by itself still has a tart bitterness due to the combination of garlic and citric acid alone that will now otherwise be nicely compensated in the compositions described herein.

5. The rehydrated garlic is packed into 5 gallon plastic pails or larger drums.

The chopped garlic in water prepared as described above is now shelf-stable with a pH of 4.0 or less, and is ready to use as an ingredient, or may be stored for later processing.

### Ingredient: Roasted Chopped Garlic

The ingredient “roasted chopped garlic” is available in a variety of particulate sizes such as ⅛ inch, ¼ inch, or whole cloves, and provides a highly desirable sweet and smoky roasted flavor profile to the compositions described herein. This ingredient is also generally available from commercial garlic processors, but has a relatively short refrigerated shelf life of approximately 7 weeks after roasting because it has not been pre-acidified by thermal processing and thus has a higher pH. The garlic is processed as described below shortly after harvest. For example, a typical processing method for “roasted chopped garlic” includes:

1. The harvested garlic bulbs are cracked, and then the cloves are peeled, washed and sorted for defects.

2. The sorted garlic cloves are then roasted in an oven for a desired time and temperature. In one embodiment, the sorted garlic cloves are roasted for approximately 8 minutes at 450° F.

3. The roasted garlic cloves are cooled and then chopped, if desired or specified, for example, into ⅛ inch or ¼ inch particulates.

4. The roasted garlic (chopped or whole) is then placed into large food service grade bags, air is removed from the bags, and the bags are fastened with a tie.

5. The bags of roasted chopped garlic are placed into industrial pack containers and immediately put into refrigerated storage between 32 to 38° F.

The roasted garlic is now ready to use as an ingredient but must be used within its short shelf life. Further, although the pH of the roasted garlic ingredient can range anywhere between 5.7 and 7.9, there is enough acidity provided by the other ingredients to keep these blended compositions under adequate pH controlprovided that the proportion of roasted garlic is adequately limited.

### Ingredient: Oil

There are many cooking oils to choose from, which may vary in type, quality, cooking properties, flavor profiles and price. For example, canola oil may provide satisfactory results at a reasonable price and is in common use for industrial processing. However, it is preferable for flavor considerations to use a very high quality first cold pressed extra-virgin olive oil. In one embodiment, Corto Extra Virgin olive oil is used to provide a special blend of three varietal olives which provides a smooth buttery flavor (as opposed to a hot and strong peppery finish) to offset the traditionally tart acidified garlic and citric acid flavor profiles.

### Ingredient: Jalapeño Peppers

1. Harvested jalapeño peppers are run through a cleaning solution, then rinsed, inspected and sorted for defects.

2. The pepper stems are removed if selected peppers will be puréed, minced, diced, chopped or sliced, as opposed to remaining whole.

3. The peppers are placed into a large tank of a salty brine (water, distilled vinegar, salt and calcium chloride ( 1/10 of 1%)) for 4 to 6 weeks.

4. The peppers are removed from the brine tanks and then chopped (if desired or specified) into ¼ inch pieces and put back into the brine solution while being packed in 5 gallon pails and larger drums.

The chopped peppers are now ready to use as an ingredient, and are acidified without the strong tart bite of citric acid while still retaining a maximum pH value of 4.0.

### Other Ingredients:

Numerous other ingredients may be added to the basic compositions of examples I, II and III, described below, bearing in mind that pH control is important for a packaged garlic product, which may be subject to state and/or federal food packaging regulations, and therefore must be a factor in determining proportions, along with desirable flavor considerations.

For example, butter and cheese are popular flavors and may be added without significant pH impact, for example, in equal parts with roasted garlic.

Many other vegetables could also be used alone or in combination including pre-acidified onions, sun-dried tomatoes, various types of brined peppers, pre-acidified mushrooms, etc. Other blend varieties could include fresh herbs, brined or acidified ginger, honey, mustard, lemons or lemon juice, peanut butter, or just about any food product, seasoning or herb that provides a nice flavor combination with garlic. One key to a successful blend of varietal formulations is utilizing shelf-stable ingredients for most of the blended composition.

### Example I

### Original Garlic Blend

1. Blend together the following ingredients in a kettle: pre-acidified chopped garlic in oil—2226 g (39.7%); pre-acidified chopped garlic in water—1726.4 g (48.6%); and olive oil—660 g (11.7%).

2. Slowly heat the blend to a light boil (212° F.), stirring every 6 minutes or as needed.

3. Maintain a slow, light boil for 8 minutes (minimum) to 25 minutes (maximum), stirring regularly as needed.

4. Hot fill jars to desired quantity by weight at a minimum temperature adequate to pasteurize the product, e.g., approximately 160° F.-190° F.<see caveat in para.50>

5. Immediately cap the jars and tighten firmly.

If necessary, depending on the size of the roasted garlic particulates, and in particular when whole roasted cloves are used, some additional time or heat treatment may be needed for the blend to equilibrate (as required by the California Department of Public Health) in the kettle and in the jar to help maintain proper pH control.

### Example II

### Roasted Garlic Blend

Blend together the following ingredients in a kettle: pre-acidified chopped garlic in oil—2721 g (36.17%); pre-acidified chopped garlic in water—2721 g (36.17%); roasted chopped garlic—1200 g (15.95%); and olive oil—880 g (11.7%), then process the blend as set forth in steps 2-5 of Example I.

### Example III

### Jalapeño Roasted Garlic Blend

In general, a flavored product may be produced by modifying the basic formulation for either the original garlic blend or the roasted garlic blend to add one or more flavor components and then processing the blend in the same manner as the basic formulation.

For example, to obtain a jalapeno flavor, blend together the following ingredients in a kettle: pre-acidified chopped garlic in oil—2721 g (31.03%); pre-acidified chopped garlic in water—1813 g (20.68%); roasted garlic chopped ¼ inch—1250 g (14.25%); brined jalapeño peppers—2105 g (24%); and olive oil—880 g (10.04%); and then perform steps 2-5 as in Example I.

### Example IV

### Honey Dijon Roasted Garlic Blend

The following formulation has slightly less than half by proportion of the pre-acidified chopped garlic components. Blend together the following ingredients in a kettle: pre-acidified chopped garlic in oil—2721 g (29.1%); pre-acidified chopped garlic in water—1814 g (19.4%); roasted garlic chopped into approximately ¼ inch pieces minimum—1500 g (16.0%); full seed Dijon mustard—1022 g (10.9%); Grade A extra light amber clover honey—1200 g (12.8%); and olive oil—1100 g (11.8%), then process the blend as set forth in steps 2-5 of Example I.

While one or more examples or embodiments have been described, they are intended to be illustrative and not limiting. Various modifications and similar arrangements will be apparent to those skilled in the art, and are intended to be within the scope of the appended claims. For example, the blends described herein may be subject to state and/or federal regulations for food packaging, which may result in changes in processing times and temperatures.

1. A composition prepared by blending together and boiling a plurality of pre-acidified garlic preparations and oil, wherein the pH of the composition is less than 4.6.

2. The composition of claim 1 further comprising roasted garlic.

3. The composition of claim 2 wherein the proportion of pre-acidified garlic preparations comprises approximately half or more of the composition.

4. The composition of claim 3 wherein the pre-acidified garlic preparations includes chopped garlic in oil and chopped garlic in water.

5. The composition of claim 4 comprising approximately equal parts pre-acidified chopped garlic in oil and pre-acidified chopped garlic in water, one-half part roasted garlic, and one-third part olive oil.

6. The composition of claim 5 comprising approximately 36% pre-acidified chopped garlic in oil, 36% pre-acidified chopped garlic in water, 16% roasted garlic, and 12% olive oil.

7. The composition of claim 1 further comprising at least one additional ingredient selected from the group of fruits, vegetables, dairy, herbs and seasonings.

8. The composition of claim 6 wherein the additional ingredient is brined chopped peppers.

9. The composition of claim 8 comprising approximately 31% pre-acidified chopped garlic in oil, 21% pre-acidified chopped garlic in water, 14% roasted garlic, 24% brined jalapeño pepper, and 12% olive oil.

10. The composition of claim 1 comprising approximately 40% pre-acidified chopped garlic in oil, 48% pre-acidified chopped garlic in water, and 12% olive oil.

11. A composition comprising at least two pre-acidified chopped garlic components and olive oil, each garlic component chopped into different sized pieces.

12. The composition of claim 11 further comprising roasted garlic.

13. The composition of claim 12 further comprising at least one additional ingredient selected from the group of fruits, vegetables, dairy, herbs and seasonings.

14. A method of preparing a garlic-based composition, comprising:
blending together the following ingredients: a plurality of pre-acidified garlic preparations, and oil;
heating the blended ingredients to a light boil and maintaining the light boil for a predetermined time period, stirring occasionally as needed; and
hot filling and thermally sealing packages with the heated blend.

15. The method of claim 14, wherein the predetermined time period ranges from approximately 8 minutes minimum to 25 minutes maximum.

16. The method of claim 14, the ingredients further including roasted garlic.

17. The method of claim 16, wherein the proportion of pre-acidified garlic preparations in the blending step comprises approximately half of the composition.

18. The method of claim 11, wherein the ingredients in the blending step include at least one additional ingredient selected from the group of fruits, vegetables, dairy, herbs and seasonings.

19. The method of claim 18, wherein the additional ingredient is brined chopped peppers.
